(19) United States
(12) Patent Application Publication
(10) Pub. No.: US 2013/0209188 A1
(43) Pub. Date: Aug. 15, 2013

(54) Machining Tool Having Zero-Backlash Ultrafine Adjustment

(71) Applicants: Peter Frank, Floh-Seligenthal (DE); Jens Neumann, Wernshausen (DE)

(72) Inventors: Peter Frank, Floh-Seligenthal (DE); Jens Neumann, Wernshausen (DE)

(21) Appl. No.: 13/581,828

(22) PCT Filed: Feb. 18, 2011
(86) PCT No.: PCT/EP2011/052424

§ 371 Date: Nov. 9, 2012

(30) Foreign Application Priority Data
Mar. 3, 2010 (DE) 10 2010 002 557.7

(51) Int. Cl. B23B 29/034

(52) U.S. Cl. CPC B23B 29/034
USPC 408/154

(57) ABSTRACT

Machining tool comprising a main tool body, a slider element received at least partially in an opening in the main tool body and movable relative thereto in an adjustment direction between a first and second position, and a drive shaft having two threaded portions, wherein the first threaded portion of the drive shaft cooperates with the threaded portion of the slider element and the second threaded portion of the drive shaft cooperates with the threaded portion of the main body so that upon rotation of the drive shaft about its axis the slider element moves relative to the main body between the first and second positions. Ultrafine adjustment of the slider element is possible in almost zero-backlash fashion in relation to the main tool body in both adjustment directions by providing a spring element engaging the slider element and biased in the direction of one of the two positions.

### RELATED APPLICATIONS

The present application is a U.S. National Phase Application of International Application No. PCT/EP2011/052424 (filed 18 Feb. 2011) which claims priority to German Application No. 10 2010 002 557.7 (filed 3 Mar. 2010).

The present invention concerns a machining tool comprising a main tool body, a slider element which is received at least partially in an opening in the main tool body and which is movable relative thereto in an adjustment direction between a first and second position, and a drive shaft having two threaded portions, wherein the slider element and the main tool body each have a respective threaded portion, wherein the first threaded portion of the drive shaft cooperates with the threaded portion of the slider element and the second threaded portion of the drive shaft cooperates with the threaded portion of the main body in such a way that upon rotation of the drive shaft about its axis the slider element can be moved relative to the main body between the first and second positions.

Such machining tools have long been known. For example a boring-out tool is known having a main tool body, at the end of which there is provided a slider element which is adjustable relative to the main tool body, the slider element being movable in the radial direction. The slider element either has a cutting portion provided to come directly into contact with the workpiece to be machined, or a seat for receiving a cutting bit.

In the known structure the slider element is in engagement with a drive shaft mounted in the main tool body by way of a thread so that the slider element can be reciprocated in the radial direction by rotation of the drive shaft. As in use the slider element carries a corresponding cutting bit the boring radius of the boring-out tool can be adjusted by means of the drive shaft.

For many situations of use highly accurate adjustment of the tool carrier relative to the main tool body is wanted. In the known machining tools therefore the thread of the drive shaft and the corresponding thread on the main tool body are frequently in the form of fine threads.

In principle fine threads are correspondingly more complicated and expensive to produce, the finer they are.

To avoid complicated and expensive manufacture of fine threads and nonetheless to be able to provide for ultrafine adjustment, it has already been proposed in DE 10 2005 045 752 that the drive shaft has a second thread cooperating with a corresponding thread in the main tool body, wherein the two threads of the drive shaft differ from each other in their pitch and/or direction of rotation.

Very fine adjustments are possible with the known constructions. It will be noted however that with the known constructions it is necessary for the adjusted boring radius to be measured off in a separate working operation when the arrangement is rotated in the adjustment direction as the use of the threads entails a corresponding thread flank play. When the adjustment direction is reversed then firstly the thread flank play of the two threads has to be taken up until a rotary movement of the drive element is converted into a radial movement of the slider element so that it is not possible to infer the radial position of the slider element on the basis of the adjusted position of the drive shaft, with a sufficiently high degree of accuracy.

Based on the described state of the art therefore the object of the present invention is to provide a machining tool of the kind set forth in the opening part of this specification, in which ultrafine adjustment of the slider element is possible in almost zero-backlash fashion in relation to the main tool body in both adjustment directions.

According to the invention that object is attained in that there is provided a spring element which engages the slider element and which is so arranged that the slider element is biased in the direction of one of the two positions of the slider element.

The biasing of the slider element, for example in the radial direction outwardly, ensures that in any position the same thread flank sides are in engagement with each other. When the direction of rotation of the drive shaft is reversed it is possible to directly implement a counter-movement of the slider element by virtue of the spring element while in the constructions in the state of the art, initially only the drive shaft is moved in the opposite direction until the engaged threads have moved from the one thread flank to the other, by virtue of their play.

In a preferred embodiment the threaded portions of the drive element are in the form of male threaded portions and the threaded portions of the main body and the slider element are in the form of female threaded portions. Thus the main body can have a corresponding bore having a female thread for receiving the corresponding threaded portion of the drive element. The slider element can be of a sleeve-shaped configuration, the sleeve having a portion with a female thread which is in engagement with the corresponding male threaded portion of the drive element.

Advantageously the two threaded portions of the drive element differ in their thread pitch and/or direction of rotation. Thus the thread pitch of the one threaded portion, for example the threaded portion of the main body, is between 0.2 and 0.7 mm/revolution and the thread pitch of the other threaded portion, for example the threaded portion of the slider element, is between 0.1 and 0.5 mm/revolution, wherein both threaded portions have a right-handed thread or both threaded portions have a left-handed thread. That measure means that the resulting movement of the slider element results from the difference in the two thread pitches.

In a further preferred embodiment the drive shaft is of a two-part construction so that it comprises a double threaded element with the two threaded portions and a drive element. The double threaded element and the drive element are preferably movable relative to each other in the adjustment direction. In a preferred embodiment however the double threaded element and the drive element are connected together in positively locking relationship in the direction of rotation about the shaft axis. Preferably the positively locking connection is formed by a substantially slot-shaped opening and a substantially blade-shaped element engaging into the slot-shaped opening. In that case the slot-shaped opening can be provided either on the double threaded element, this corresponding to the preferred embodiment, or on the drive element, while the blade-shaped element is arranged on the other elements, that is to say in the preferred embodiment on the drive element. The engagement of the blade-shaped element into the slot-shaped opening means that, by rotation of the drive element, the torque can be transmitted to the double threaded element in positively locking relationship.

The connection of the double threaded element to the main tool body by way of a thread provides that, upon actuation of the drive element, not just the slider element but also the double threaded element are moved in the adjustment direction (for example in the radial direction relative to the main tool body), but to differing extents. The fact that the drive element and the double threaded element are connected by way of the blade-shaped element and the slot-shaped opening provides that the drive element can be held in its position in the adjustment direction without endangering the functionality of the adjustment device. In contrast to the constructions in the state of the art therefore, upon adjustment of the slider element the drive element is not rotated into and out of the bore in the main body, but remains in place in the adjustment direction, for example in the radial direction.

In a preferred embodiment the drive shaft has a splined portion having a plurality of recesses or grooves, wherein the main tool body has an elastic projection which is arranged in relation to the splined portion in such a way that upon rotation of the drive shaft the projection successively engages into a plurality of recesses of the splined portion. In that way the elastic projection can be for example in the form of a pressure portion biased with a spring element. That measures provides that the user of the machining tool has a feedback which can be felt and generally also heard, when adjusting the drive element. The corresponding grooves can be arranged equidistantly so that for example rotation of the drive element to an extent such that the elastic projection engages just from one groove into the next one causes a displacement of the slider element by 1/1000 mm.

In a particularly preferred embodiment the threaded portion of the main body and/or the threaded portion of the spindle element are formed by a sleeve which is separate but which is fixedly connected in the main body and spindle element respectively, wherein the sleeve is preferably formed from a copper tin zinc casting alloy.

Further advantages, features and possible uses of the present invention will be apparent from the description hereinafter of a preferred embodiment and the accompanying Figures in which:

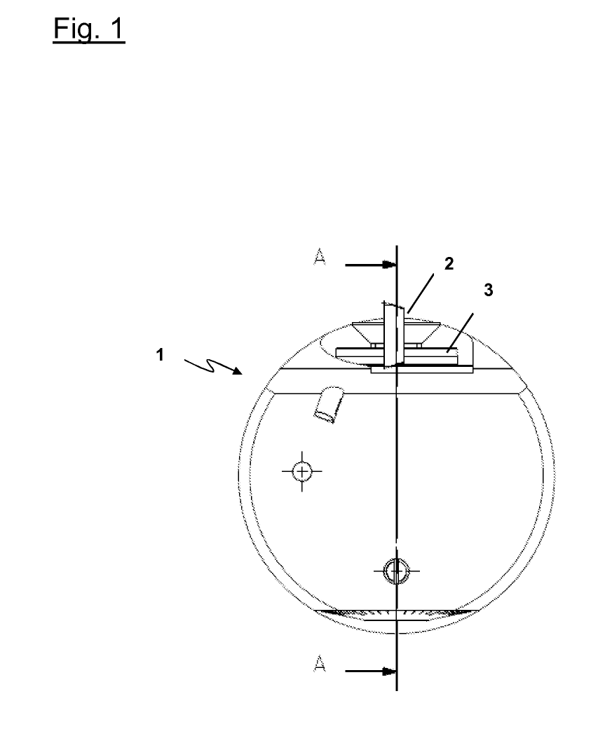

FIG. 1 shows a view from below of a preferred embodiment of the invention,

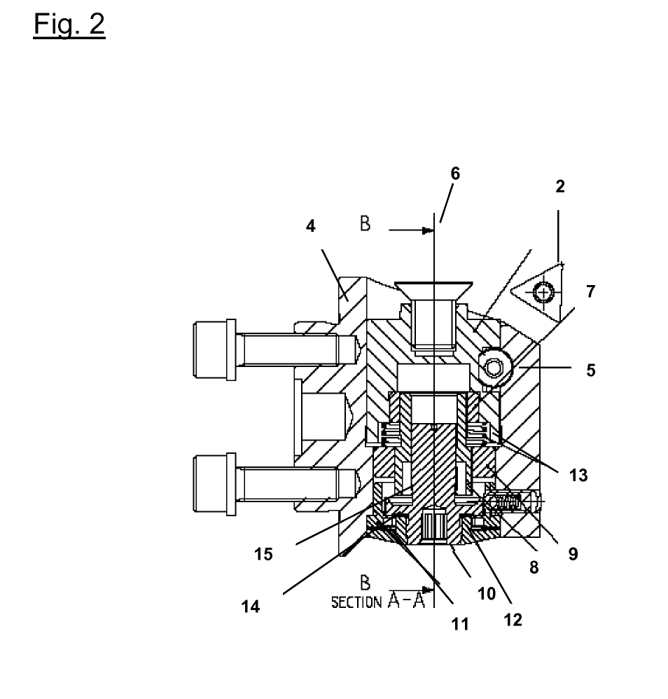

FIG. 2 shows a sectional view along line A-A in FIG. 1,

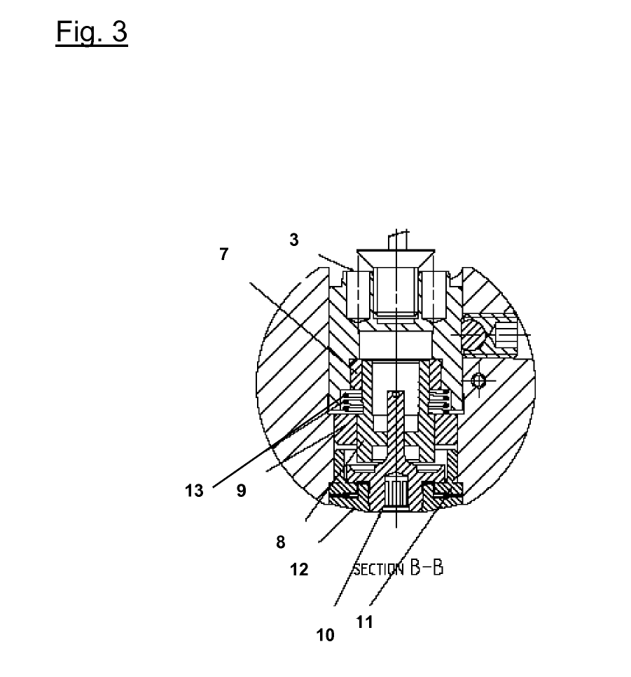

FIG. 3 shows a sectional view along line B-B in FIG. 2,

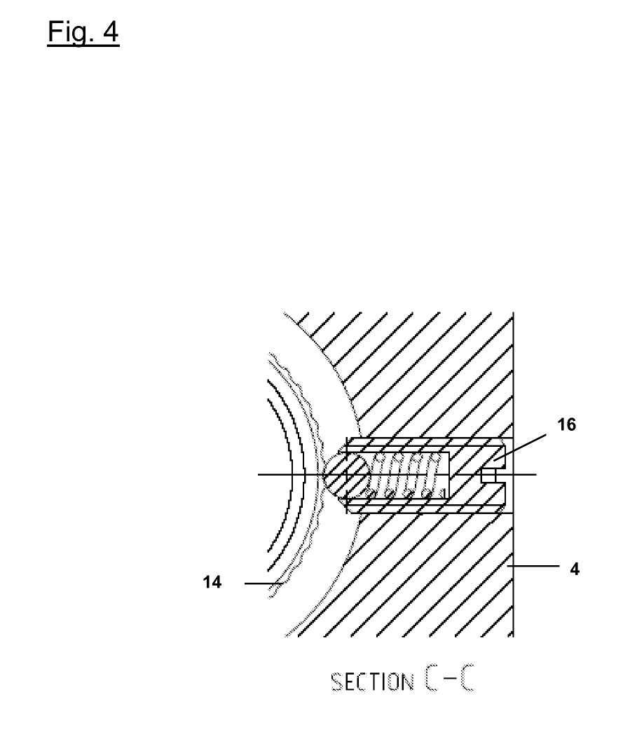

FIG. 4 shows a partly sectional view along line C-C in FIG. 2, and

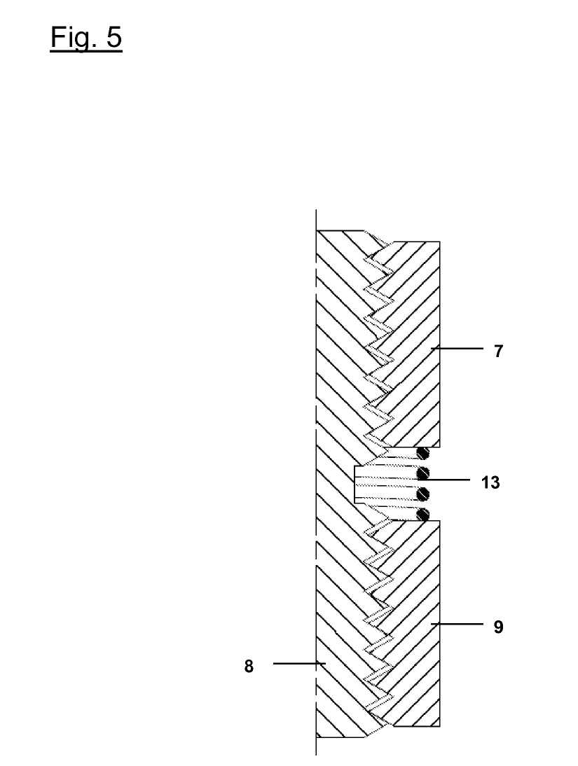

FIG. 5 shows a diagrammatic view of the threaded portions including the spring element.

FIG. 1 shows an embodiment of the invention. The machining tool 1 with a cutting bit 2 held on a slider element 3 is to be seen in a view from below. For the sake of enhanced clarity of the drawing the holder for the cutting bit 2 in the slider element 3 is not shown.

It will be seen from the sectional view in FIG. 2 that the slider element 3 is received in a suitable stepped bore in the main tool body 4. The slider element is of a substantially sleeve-shaped configuration and is prevented from rotation about the axis 6 by means of a rotation-preventing means 5.

Arranged in the interior of the slider element 3 is a bush 7 fixedly connected to the slider element 3. The bush can be produced for example from gun metal. The bush 7 has a female thread providing the threaded portion, mentioned in the opening part of this specification, of the slider element. The slider element 3 is of an outside diameter which substantially corresponds to the inside diameter of the part of the bore in the main tool body housing, of larger inside diameter. The female thread of the bush 7 comes into engagement with a threaded portion of a double threaded spindle 8. The double threaded spindle 8 has a second threaded portion engaging with a main body bush 9 connected to the main body 4. The main body bush 9 can also be made from gun metal. The double threaded spindle, together with the drive element in the form of a sword spindle 10, forms the drive shaft. The double threaded spindle 8 has a slot-shaped opening in which a plate-shaped or blade-shaped portion of the sword spindle 10 engages.

The sword spindle 10 is held in the portion of smaller diameter of the main tool body stepped bore, by means of a leg element 11.

The sword spindle 10 can be rotated about its longitudinal axis 6 for adjustment of the slider element and therewith the exact position of the cutting bit 2. Because the blade-shaped element of the sword spindle fits in the slot-shaped opening in the double threaded spindle the rotary movement of the sword spindle 10 is transmitted to the double threaded spindle 8. As the double threaded spindle 8 runs in a thread of the main body bush 9, that rotary movement leads to a radial movement of the double threaded spindle 8. In a preferred embodiment the main body bush 9 has a thread pitch of 0.3 mm per revolution.

At the same time the double threaded spindle 8 engages with its second thread which in a preferred embodiment can have a pitch of 0.25 mm per revolution into the female thread on the slider bush 7. That results in the slider element 3 not performing the movement in the radial direction of the double threaded spindle 8 over its full periphery as the second thread provides that the slider element 3 moves in the radial direction relative to the double threaded spindle 8. As a result the slider element moves by the difference between the two thread pitches, that is to say by 0.05 mm per revolution of the sword spindle.

The slider element 3 can thus be finely adjustment in the radial direction by rotation of the sword spindle 10. Besides the knife-shaped or blade-shaped portion 15 the sword spindle 10 has a disk portion 14, the disk at its outside edge having a multiplicity of grooves forming recesses.

As can be seen in particular from FIG. 4 arranged in the main tool body 4 is a resiliently biased pressure portion 16 which engages into the corresponding grooves of the disk-shaped portion 14 of the sword spindle 10. When the spindle 10 is rotated therefore the pressure portion 16 can be heard and felt to latchingly engage into the corresponding grooves in the disk-shaped portion 14 of the sword spindle 10.

If the disk-shaped element 14 has for example 50 equidistantly arranged grooves then the thread pitches of the corresponding threaded portions can be so selected that each “click”, that is to say each rotation of the sword spindle 10 through 1/50 of a revolution and thus from one groove to another corresponds to a radial movement of the slider element 3 through 1/1000 mm. According to the invention there is provided a spring element 13 which in the illustrated embodiment engages both the main body 4 or the main body bush 9 fixed to the main body 4, and also the slider element 3, and presses the slider element 3 outwardly, that is to say away from the sword spindle 10. As the threads involved necessarily have a certain play, the situation diagrammatically shown in FIG. 5 occurs. It will be clearly seen that the thread portions which are in engagement respectively only bear against the left-hand or the right-hand thread flank respectively. That situation occurs also when the slider element 3 is moved outwardly in the radial direction by means of the sword spindle 10. If however the direction of rotation of the sword spindle 10 is reversed, that is to say if the slider element 3 should be further moved into the main body 4, then without the spring element 13 the thread flank play would firstly be taken up in the first thread connection between the main body bush 9 and the double threaded spindle and then in the next step the thread flank play would also be taken up between the double threaded spindle 8 and the slider bush 7. It is only after both thread connections have changed the thread flanks that further rotation of the sword spindle 10 would cause a movement of the slider element 3.

Without the spring element 13, in the case of the described configuration, it can happen that the sword spindle has to be rotated through between 15 and 20 “clicks”, that is to say between 15/50 and 20/50 revolutions before the slider element is moved in the opposite direction. Drawing a conclusion from the position of the sword spindle 10 in regard to the exact position of the slider element 3 is thus not possible.

The arrangement according to the invention of the spring element 13 effectively prevents a thread flank change by virtue of the thread flank play, both in the first and also in the second threaded portion of the double threaded spindle 8. Without that flank change the two threads remain completely play-free so that now in actual fact it is possible to arrive at a conclusion about the radial position of the cutting bit 2, on the basis of the position of the sword spindle 10. Therefore the embodiment shown in FIGS. 1 through 4 additionally has a scale disk 12, on the basis of which the rotary position of the sword spindle 10 can be read off.

### LIST OF REFERENCES

1 machining tool

2 cutting bit

3 slider element

4 main tool body

5 rotation-preventing means

6 axis

7 slider bush

8 double threaded spindle

9 main body bush

10 sword spindle

11 leg element

12 scale disk

13 spring element

14 disk-shaped portion

15 blade-shaped portion

16 pressure portion

1. A machining tool comprising a main tool body, a slider element which is received at least partially in an opening in the main tool body and which is movable relative thereto in an adjustment direction between a first and second position, and a drive shaft having two threaded portions, wherein the slider element and the main tool body each have a respective threaded portion, wherein a first threaded portion of the drive shaft cooperates with the threaded portion of the slider element and a second threaded portion of the drive shaft cooperates with the threaded portion of the main body in such a way that upon rotation of the drive shaft about its axis the slider element can be moved relative to the main body between the first and second positions, wherein there is provided a spring element which engages the slider element and which is so arranged that the slider element is biased in the direction of one of the two positions.

2. A machining tool as set forth in claim 1 wherein the threaded portions of the drive shaft are in the form of male threaded portions and the threaded portions of the main body and the slider element are in the form of female threaded portions.

3. A machining tool as set forth in claim 1 wherein the two threaded portions of the drive shaft differ in their thread pitch and/or direction of rotation.

4. A machining tool as set forth in claim 3 wherein the thread pitch of one threaded portion is between 0.2 and 0.7 mm/revolution and the thread pitch of the other threaded portion is between 0.1 and 0.5 mm/revolution.

5. A machining tool as set forth in claim 1 wherein the drive shaft is of a two-part construction and has a double threaded element with the two threaded portions and a drive element.

6. A machining tool as set forth in claim 5 wherein the double threaded element and the drive element are movable relative to each other in the adjustment direction.

7. A machining tool as set forth in claim 5 wherein the double threaded element and the drive element are connected together in positively locking relationship in the direction of rotation around the shaft axis.

8. A machining tool as set forth in claim 1 wherein the drive shaft has a splined portion having a plurality of recesses, wherein the main tool body has an elastic projection which is arranged in relation to the splined portion in such a way that upon rotation of the drive shaft the projection successively engages into a plurality of recesses of the splined portion.

9. A machining tool as set forth in claim 1 wherein the threaded portion of the main body and/or the threaded portion of the spindle element is formed by a sleeve.

10. A machining tool as set forth in claim 9 wherein the sleeve is formed from a copper tin zinc casting alloy.

11. A machining tool as set forth in claim 7 wherein the positively locking connection is formed by a substantially slot-shaped opening and a substantially blade-shaped element engaging into the slot-shaped opening, and wherein the slot-shaped opening is arranged either on the double threaded element or the drive element and the blade-shaped element is arranged on the other element.

12. A machining tool as set forth in claim 2 wherein the two threaded portions of the drive shaft differ in their thread pitch and/or direction of rotation.
